(19) United States
(12) Patent Application Publication
(10) Pub. No.: US 2024/0197109 A1
(43) Pub. Date: Jun. 20, 2024

(54) USER GUIDANCE FOR A FOOD PREPARATION DEVICE

(71) Applicant: Instant Brands Holdings Inc., Downers Grove, IL (US)

(72) Inventor: Shuang Xu, Downers Grove, IL (US)

(73) Assignee: Instant Brands Holdings Inc., Downers Grove, IL (US)

(21) Appl. No.: 18/541,821

(22) Filed: Dec. 15, 2023

Related U.S. Application Data
(60) Provisional application No. 63/476,209, filed on Dec. 20, 2022.

(51) Int. Cl. A47J 36/32; A47J 27/08; A47J 37/06; G06F 9/451

(52) U.S. Cl. CPC A47J 36/321; A47J 27/0802; A47J 37/0641; G06F 9/453

(57) ABSTRACT

A food preparation device can be improved by providing guidance to a user. The guidance may include identifying appropriate options or functions for the food preparation to simplify the process for the user. The guidance may include analyzing an initial instruction for the food preparation to identify subsequent preparation actions. The guidance may include a limited option subset for a next instruction for the food preparation based on the analysis.

### PRIORITY

This application claims priority to Provisional Pat. App. No. 63/476,209, filed Dec. 20, 2022, entitled “USER GUIDANCE FOR A FOOD PREPARATION DEVICE,” the entire disclosure of which is herein incorporated by reference.

### TECHNICAL FIELD OF THE INVENTION

The present invention relates to a food preparation device that provides guidance for a user with regard the preparation of the food.

### BACKGROUND

Food preparation devices may include instructions for preparing and/or cooking food. However, for more complicated food preparation devices or for coordinating multiple functions, additional guidance may be beneficial.

### BRIEF SUMMARY

The present invention relates to a method, system or apparatus and/or computer program product for an improved food preparation device that that provides guidance for a user with regard the preparation of the food. The guidance may include identifying appropriate options or functions for the food preparation to simplify the process for the user. The guidance may include analyzing an initial instruction for the food preparation to identify subsequent preparation actions. The guidance may include a limited option subset for a next instruction for the food preparation based on the analysis.

In one embodiment, a method for food preparation includes receiving an initial instruction for the food preparation; analyzing the initial instruction to identify subsequent preparation actions depending on the initial instruction; and providing guidance based on the analysis, wherein the guidance comprises a limited option subset for a next instruction for the food preparation. The analyzing comprises determining a sequence for the food preparation and the subsequent preparation actions are the next instruction in the sequence. The initial instruction comprises one or more functions for preparing the food. The one or more functions comprise at least one of a cooking, frying, air frying, baking, roasting, broiling, reheating, steaming, dehydrate, defrosting, microwaving, pressure cooking, slow cooking, sautéing, searing, grilling, coffee grinding, brewing, dispensing, or blending. The method includes measuring, with one or more sensors, one or more conditions of the food; and modifying the guidance based on the measured one or more conditions. The condition comprises a weight, temperature, humidity, density, volume, crispiness, or burned particle.

In another embodiment, a food preparation device includes one or more food preparation functions selectable by a user; a guidance circuit configured to: receive an initial instruction for the selected function; analyze the initial instruction to identify subsequent functions depending on the initial instruction; and providing guidance based on the analysis, wherein the guidance comprises a limited subset of the functions for a next instruction. The analysis comprises determining a sequence for the functions and the next instruction in the sequence is a next function in the sequence. The initial instruction comprises one or more of the functions for preparing the food. The one or more functions comprise at least one of a cooking, frying, air frying, baking, roasting, broiling, reheating, steaming, dehydrate, defrosting, microwaving, pressure cooking, slow cooking, sautéing, searing, grilling, coffee grinding, brewing, dispensing, or blending. The guidance circuit is further configured to: measure, with one or more sensors, one or more conditions of the food; and modify the guidance based on the measured one or more conditions. The condition comprises a weight, temperature, humidity, density, volume, crispiness, or burned particle. A food preparation system includes the food preparation device described above and an electronic device communicating with the food preparation device. The electronic device comprises a mobile device with an application for interacting with the food preparation device. In some embodiments, a device includes a processor and a memory, and the processor is configured to read code from the memory and implement any of the embodiments discussed above.

In some embodiments, a computer program product comprises a computer-readable program medium code stored thereupon, the code, when executed by a processor, causes the processor to implement any of the embodiments discussed above. In some embodiments, there is an apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any of the embodiments. The above and other aspects and their implementations are described in greater detail in the drawings, the descriptions, and the claims.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates a block diagram of a preparation device.

FIG. 2 illustrates a block diagram of a guidance circuit for the preparation device.

FIG. 3 illustrates a block diagram of a user interface for a preparation device.

FIG. 4 illustrates an example user interface for a preparation device.

FIG. 5 illustrates a second example user interface for a preparation device.

FIG. 6A illustrates a third example user interface for a preparation device.

FIG. 6B illustrates an alternative preset for the preparation device from the third example user interface.

FIG. 6C illustrates an alternative preset for the preparation device from the third example user interface.

FIG. 7 illustrates a block diagram of another example preparation device with an electronic device for guidance.

FIG. 8 illustrates example inputs and outputs for guidance.

FIG. 9 illustrates a flow process for one example of guidance with a preparation device.

FIG. 10 illustrates a flow process for example functions.

### DETAILED DESCRIPTION OF THE DRAWINGS AND PREFERRED EMBODIMENTS

By way of introduction, the disclosed embodiments relate to an improved food preparation device that provides certain guidance to a user. The guidance may include identifying appropriate options or functions for the food preparation to simplify the process for the user. The guidance may include analyzing an initial instruction for the food preparation to identify subsequent preparation actions. The guidance may include a limited option subset for a next instruction for the food preparation based on the analysis.

In some embodiments, food preparation or cooking guidance may include:
A) showing available functions and options;
B) limiting settings to a valid range;
C) showing current cooking status;
D) guiding users through a step-by-step cooking task/experience;
E) prompting context-based cooking instructions;
F) displaying warnings or alerts when error is detected;
G) providing additional information or explanation of the chosen option; and/or
H) adjusting cooking settings to support customized recipe or preferences.
   As described below, the guidance may include a number of these elements. For example, embodiments shown below guiding users through a step-by-step task with context-based cooking instructions that prompted and displayed. The guidance may provide instruction for any issues/errors that may include alerts.

FIG. 1 illustrates a block diagram of a preparation device 102. The preparation device 102 may include multiple functions 103a-103n. The functions may be different operations or preparation mechanisms. Specifically, the functions may provide different ways to prepare the food and may be used independently or together. Examples of different food preparation functions 103a-103n include cooking, pressure cooking, slow cooking, frying, microwaving, roasting, reheating, steaming, dehydrate, broiling, defrosting, baking, sautéing, searing, grilling, coffee grinding, brewing, dispensing, or blending. The preparation device 102 may be any device that provides any of the functions 103a-103n in the examples above. The preparation device 102 may be an air fryer, microwave, oven, steamer, pressure cooker, slow cooker, coffee maker, blender, grill, or any combination of those. In some embodiments, the preparation device 102 may also include beverage preparation, but will be described as food preparation for simplicity.

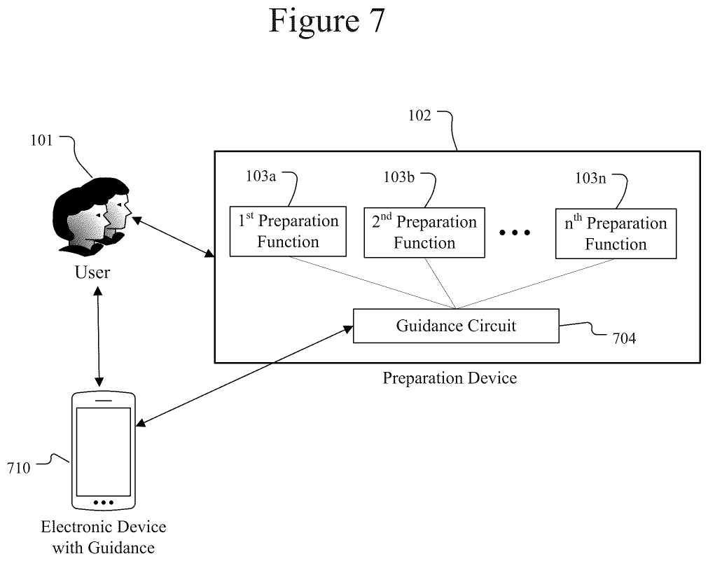

FIG. 1 illustrates a number of preparation functions 103. In one example, there is a first preparation function 103a, a second preparation function 103b, or an nth preparation function 103n, where n is an integer greater than one. The functions may be controlled by the guidance circuit 104, which provides the guidance. The guidance described herein may relate to guidance for individual functions or guidance for a series of functions. Guidance described below may also be referred to as staged cooking or guided cooking, which may also be different embodiments of guidance. In some embodiments, guidance may be directed by the preparation device itself (e.g. FIG. 1) or may be directed by an external electronic device (e.g. FIG. 7).

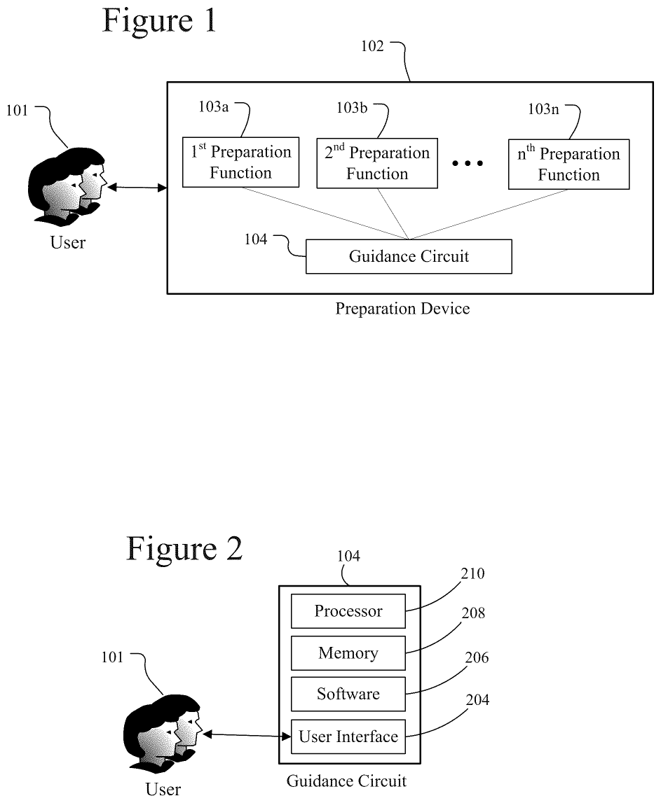

A user 101 may operate the preparation device 102. There may be an interface that includes functionality for receiving input and displaying output with the user 101. Examples of this functionality are described below with respect to the user interface 204 in FIG. 2.

The functions 103a-103n may include different food preparation functions. The guidance circuit 104 can be used to provide guidance to the user 101 for operating one or more of the functions 103a-103n. The guidance circuit 104 is further described with respect to FIG. 2. In particular, the guidance circuit 104 may provide guidance for a user 101 to utilize one or more of the functions 103a-103n, including combinations of different functions as part of the food preparation process.

FIG. 2 illustrates a block diagram of the guidance circuit 104 of the preparation device 102. The guidance circuit 104 may be referred to as a computing device, processor, circuit board, chip, or microcomputer through which computations or processes are performed. In one embodiment, the guidance circuit 104 may be software that runs on a computing device as shown in FIG. 2. The guidance circuit 104 may include a processor 210, a memory 208, software 206 and/or a user interface 204. In alternative embodiments, the guidance circuit 104 may be multiple devices to provide different functions and it may or may not include all of the user interface 204, the software 206, the memory 208, and/or the processor 210. While described as the guidance circuit 104, it may include functionality for controlling other aspects of the preparation device 102, including but not limited to the preparation functions 103a-103n. In one embodiment, there may be single circuit or processor for providing guidance, controlling the preparation device 102 and the functions 103a-103n. In other embodiments, there may be a separate processor from the guidance circuit 104. For simplicity, the guidance and functions are described as being controlled by the guidance circuit 104.

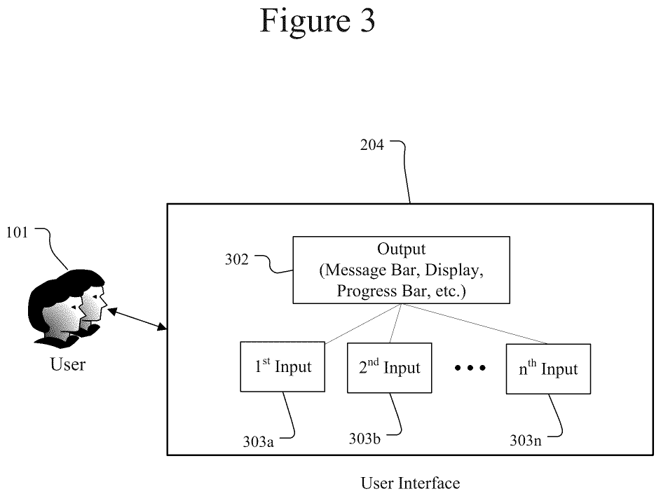

The user interface 204 may allow for communication to/from the user 101. Examples of the user interface 204 are further described with respect to FIGS. 3-6. The user interface 204 may include a display, which may be separate from the guidance circuit 104, or it may provide inputs to and outputs from the guidance circuit 104. The preparation device 102 may include a user interface 204 for providing information to the user 101. In one embodiment, the user interface 204 may be a display, such as a message bar, coupled with the processor 210 and configured to display an output from the processor 210. The display (not shown) may be a liquid crystal display (LCD), an organic light emitting diode (OLED), a flat panel display, a solid-state display, a cathode ray tube (CRT), or other now known or later developed display device for outputting determined information. The display may act as an interface for the user to see the functioning of the processor 210, or as an interface with the software 206 for providing the guidance for operating the functions of the preparation device.

In some embodiments, the user interface 204 may also provide a mechanism for the user 101 to interact with the preparation device 102, such as by providing commands with a user input. The commands may be part of the guidance and provide inputs for the functions 103a-103n by the user 101. In some embodiments, the user interface 204 may include buttons, touch screen display, a keypad or a cursor control device, a remote control, a wireless device (e.g. computing device, smartphone, tablet, etc.) or any other device operative to allow a user or administrator to interact with the preparation device 102. In some embodiments, the interface may include a voice control or audio input for receiving commands and/or providing feedback as part of the guidance. In other embodiments the user interface 204 may include inputs for scanning (e.g. scanning a food/recipe code) or sensor inputs (e.g. scale, temperatures, etc.), or any other mechanism to accept user information about the functions and/or food being prepared. This may include any information about what is being prepared/cooked (including but not limited to a recipe) that can help define the proper cooking time, which may be part of the guidance.

The guidance described herein may be communicated through the user interface 204. Other examples of the user interface 204 are described with respect to FIGS. 3-6. The guidance may include information about the functions, including inputs/outputs for food preparation settings (e.g. function, time, temperature, pressure, weight, humidity, density, etc.). The user interface 204 display (e.g. message bar in FIGS. 3-6) may display information about the cooking settings or functions.

FIG. 3 illustrates a block diagram of a user interface 204 for a preparation device. The user interface 204 may allow for interaction by a user 101 with the preparation device. The example user interface in FIG. 3 illustrates a first input 303a, a second input 303b, through an nth input 303n, where n is an integer. The inputs may include buttons, knobs, dials, a touch screen display, touch screen buttons, a keypad or a cursor control device, a remote control, a wireless device (e.g. computing device, smartphone, tablet, etc. as in FIG. 7) or any other device operative to allow a user to interact with the preparation device 102. The inputs 303a-303n allow the user to provide instructions to the preparation device. In some embodiments, those instructions from the user 101 that are provided at the inputs 303a-303n may be as a result of guidance provided. In one embodiment, there may be an output 302 that provides feedback to the user 101. In some embodiments the output 302 may include and/or be referred to as a message bar. In other examples, the output 302 may be any type of display or progress bar used to convey information to the user. The provided feedback may include guidance for instructing the user 101 for utilizing one or more of the functions of the preparation device. The output 302 may display available functions and instructions or recommendations for those functions.

The output 302 may be one example of a display or output providing guidance. It may include an explanation of settings, provide warnings, or provide predefined preparation instructions. Although guidance may be described as instructions in several embodiments, it may also include settings information or warnings. The output 302 may further provide detailed cooking status and progress of the preparation. Settings for the food preparation device may be displayed on the output 302, including cooking level, temperature, etc. There may also be a progress bar that shows where in a sequence of functions, the food preparation device is.

The guidance may include specific instructions to the user. In addition to instructions for the sequence of functions or the next function, there may be instructions for changes to make to the food or the current preparation. For example, adding food, turning food, opening lid, waiting, and/or cooling are possible guidance instructions for the user that may be displayed on the output 302. There also may be error messages, such as close lid, lock lid, or other error conditions that are displayed by the output 302.

In some embodiments, the output 302 may also include an input as part of it. In other words, one of the inputs 303 may be part of the output 302, such as a message bar. In one embodiment, the message bar can also be used to accept user's entry. There may be an independent input (e.g. knob/button/touchscreen) to traverse through predefined options displayed on the message bar. The user can also confirm the selection through the same or different input. This allows the user to specify or customize cooking needs. In some embodiments, that information (the cooking needs) can be relayed through other devices (e.g. an app on a smartphone), but for this particular embodiment, inputs are provided for the user to input this information without relying on another device.

In some embodiments, the food preparation device may provide personalized guided food preparation with context-based intelligence that may automate and optimize food preparation settings based on user input and/or sensors. The guidance may include an analysis for optimizing user interaction and efficiency in the preparation.

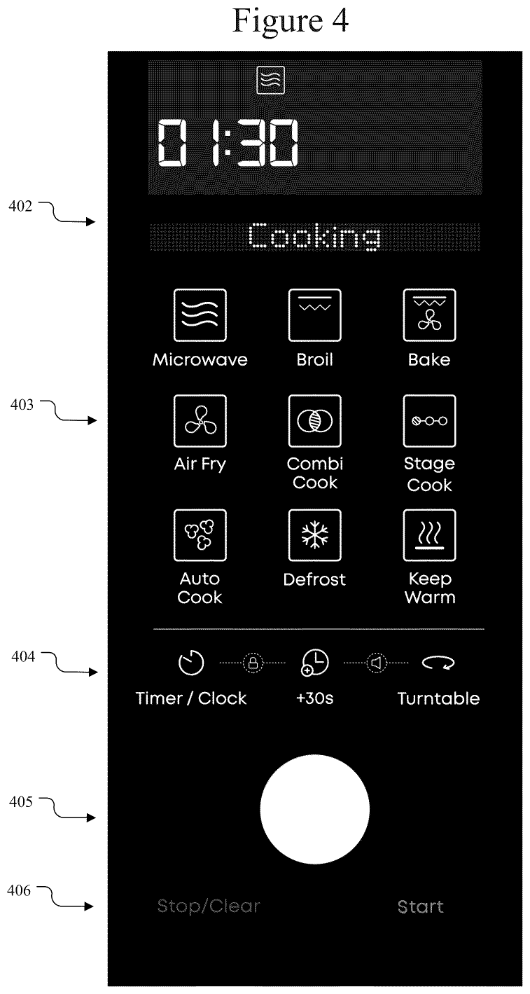

FIG. 4 illustrates an example user interface for a preparation device. The user interface shown in FIG. 4 is one example an interface for the preparation device. There may be additional inputs and/or outputs. In some embodiments, there may be one or more outputs 302. In FIG. 4, the example output is the message bar 402 that provides feedback to the user and in this example, the message bar 402 provides an indication of the function of the device, which is “Cooking” in this example. Different functions 403 are illustrated in FIG. 4 and include Microwave, Broil, Bake, Air Fry, Combi Cook, Stage Cook, Auto Cook, Defrost, or Keep Warm. These functions are examples of the functions 103a-103n illustrated in FIG. 1. The functions 403 may each be an input (e.g. button) that is selected by the user. The interface further illustrates additional functions 404 that include changes to the Timer/Clock, Adding 30 Seconds, or adjusting the Turntable. There may be an interactive button/knob 405 for providing additional selections. Finally, FIG. 4 illustrates a Stop/Clear button and a Start button 406.

For the example function 403, Stage Cooking may be established by the message bar 402 guiding the user through each stage for the process. For example, the message bar may communicate the function/time/temperature for each stage. This can be provided after receiving user input for initial setup. For transitions between stages, the message bar 402 may also guide the user to shift between each stage (e.g. when the user must make a change, such as adding an ingredient at one stage.

The interface in FIG. 4 illustrates functions of a preparation device. As described below, there may be guidance for using those functions. In one example, the guidance may be communicated to the user through the message bar 402. In other embodiments, the guidance may be communicated to the user through additional displays on the preparation device or through a separate device (e.g. an electronic device in FIG. 7).

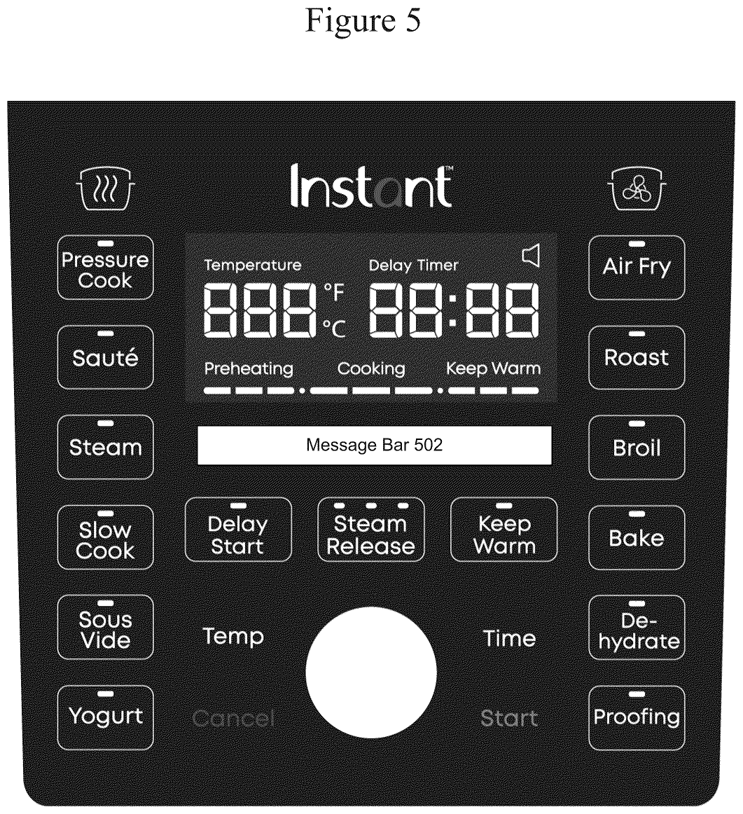

FIG. 5 illustrates a second example user interface for a preparation device. FIG. 5 illustrates an alternative interface to the interface shown in FIG. 4. Different preparation devices may have different interfaces and arrangements of inputs/outputs. Example functions shown in FIG. 5 include Pressure Cook, Sauté, Steam, Slow Cook, Sous Vide, Yogurt, Air Fry, Roast, Broil, Bake, Dehydrate, and Proofing. Additional operations include Delay Start, Steam Release, and Keep Warm. In FIG. 5, the message bar 502 is shown in the middle of this example interface. In addition, there is another display above the message bar that is another example of different Outputs 302 that displays the temperature, timer, and operations (preheating, cooking, and keep warm) in this embodiment. Although not labeled, the progress bar is shown under functions (Preheating, Cooking, Keep Warm). The temperature and time may be further adjustable, such as through a knob or other input.

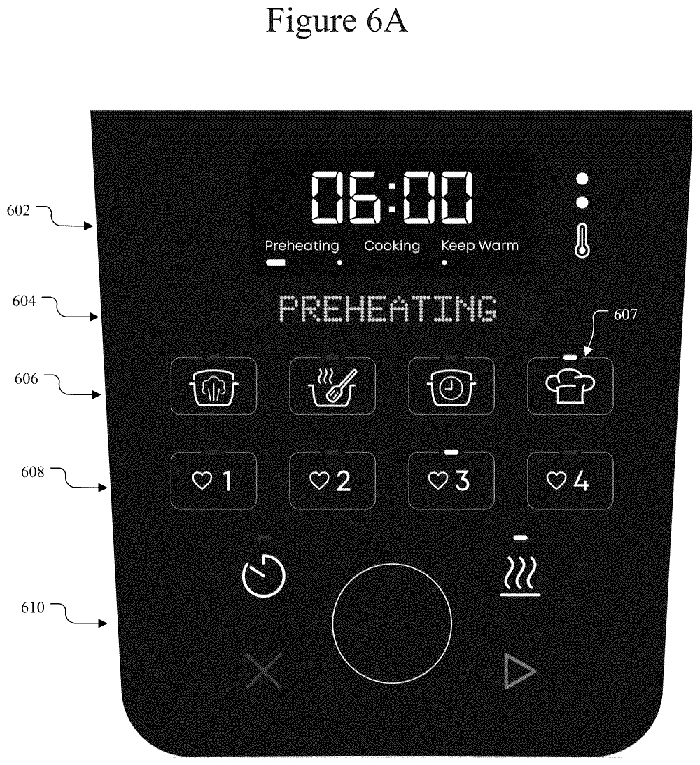

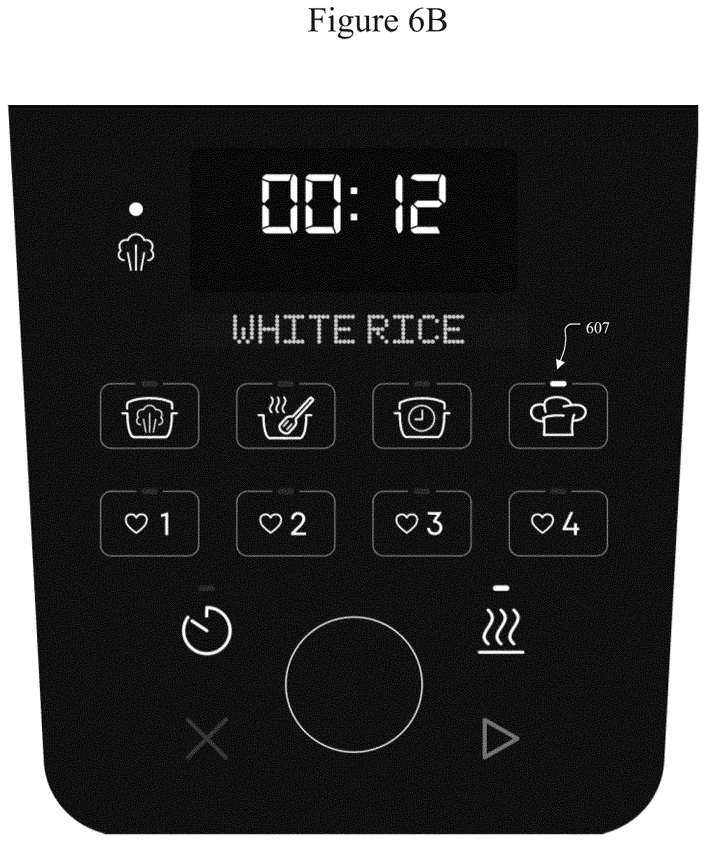

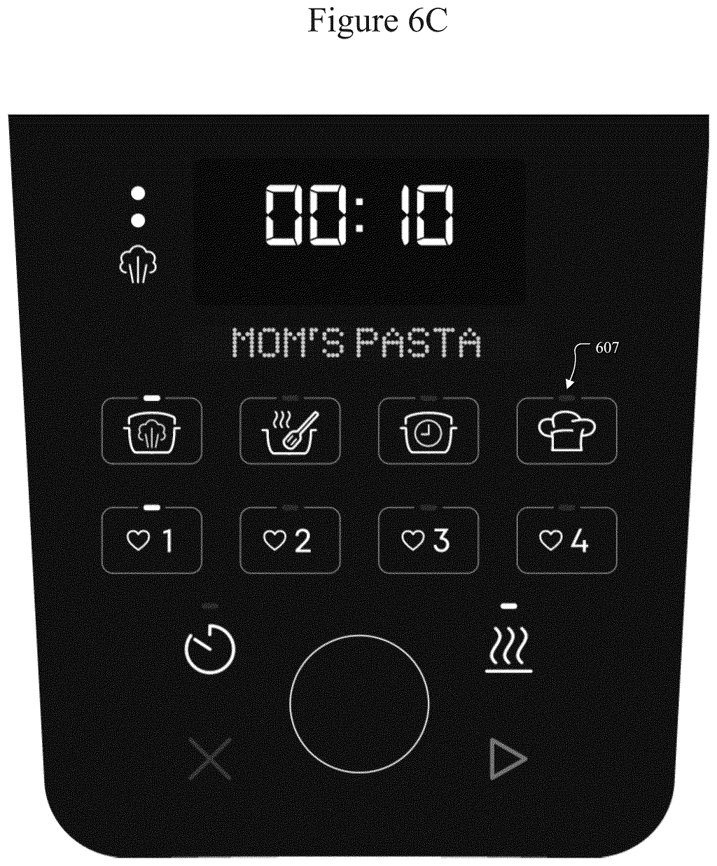

FIG. 6A illustrates a third user interface that may include the functions and guidance illustrated and described with respect to FIGS. 3-5. Different preparation devices may have different interfaces and arrangements of inputs/outputs. Different preparation devices may have different interfaces and arrangements of inputs/outputs. Any of the features shown and described with respect to each of FIGS. 3-6C may be interchangeable and may be applicable in each respective embodiment.

The example display 602 may include the time with a tracking of each cooking stage shown (e.g. preheating, cooking, keep warm, etc.). Adjacent the display may be control for temperature or pressure. As described above, there may be a message bar 604 for a moving display of text that includes instructions. The message bar 604 as discussed herein may display scrolling words for communicating with the user. The words can be in multiple languages. The example function buttons 606 may include access to distinct cooking functions and access to a preset library. For example, this may include pressure cook, sauté, slow cook, and preset selection/feature 607.

The preset library feature 607 may also be referred to as a recipe library or a chef assist function that provides cooking recommendations for the user. The user can rotate the knob to browse through a list of predefined presets such as Rice, Beef, Chicken, Cake, etc., which are displayed on the message bar with its cooking settings shown on the panel (and illustrated in FIGS. 6B-6C). The user can press the knob to select a preset, as well as see and change its default cooking setting before use this recommended recipe to cook. In some embodiments, the descriptions can be customized (e.g. “Weekend Chili”) by the user. FIGS. 6B-6C illustrate alternative presets 607 for the preparation device from the third example user interface. Specifically, FIG. 6B illustrates a preset for “white rice”, while FIG. 6C illustrates a preset for “mom's pasta.” The presets that are viewed in FIGS. 6B-6C may be selected from the preset library and/or customized by the user (including all cooking parameters/functions and the naming of the preset). Specifically, the naming of the preset may include the preset buttons 608.

Preset/favorite buttons 608 depict another feature for the user to store the most frequently used functions in one of the buttons 608 as a shortcut. For displayed cooking settings (from a default or updated cooking function or from a selected preset), the user can long press one of the preset buttons 608 to save it. A short press on a defined preset button 608 will retrieve the stored cooking settings. In addition, when saving cooking settings into a preset button 608, the user can view and select a preferred name from a predefined list to label this preset button 608 as shown in FIGS. 6B-6C.

Additional buttons 610 are shown that include cancel (X button) and start (triangle). The large circle may be a knob that can be turned in either direction for scrolling through the options which are shown in the message bar 604. The knob provides a mechanism to receive user feedback.

Referring back to FIG. 2, the processor 210 in the guidance circuit 104 may include a central processing unit (CPU), a graphics processing unit (GPU), a digital signal processor (DSP) or other type of processing device. The processor 210 may be one or more general processors, digital signal processors, application specific integrated circuits, field programmable gate arrays, servers, networks, digital circuits, analog circuits, combinations thereof, or other now known or later developed devices for analyzing and processing data. The processor 210 may operate in conjunction with a software program (i.e. software 206), such as code generated manually (i.e., programmed). The software 206 may include functionality for user interaction including providing the guidance.

The processor 210 may be coupled with the memory 208, or the memory 208 may be a separate component. The software 206 may be stored in the memory 208. The memory 208 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 208 may include a random access memory for the processor 210. Alternatively, the memory 208 may be separate from the processor 210, such as a cache memory of a processor, the system memory, or other memory. The memory 208 is operable to store instructions executable by the processor 210.

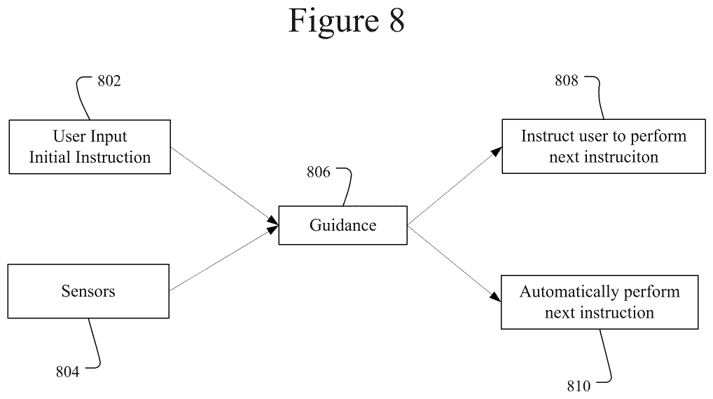

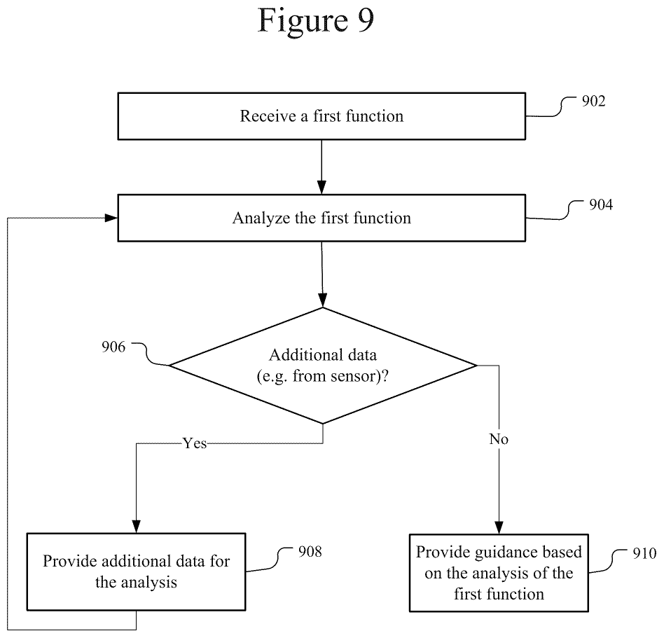

The functions, acts or tasks illustrated in the figures (e.g. FIGS. 8-9) or described herein may be performed by the programmed processor executing the instructions stored in the software 206 or the memory 208. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 210 is configured to execute the software 206.

FIG. 7 illustrates a block diagram of another example preparation device with an electronic device for guidance. FIG. 7 is an alternative example of FIG. 1. Specifically, FIG. 7 illustrates the presence of an electronic device 710 that can provide guidance. The electronic device 710 may be a computing device, such as a laptop, tablet, smartphone, mobile device, etc. In the embodiment, where the electronic device 710 is a mobile device, there may be an application (i.e. “app”) that connects with the preparation device 102. The connected app may provide inputs/outputs to the preparation device 102. In one example, the connected app may provide instructions to or receive instructions from the guidance circuit 704. The guidance circuit 704 may be the same or different from the guidance circuit 104 in FIG. 1. In some embodiments, the functionality of the guidance circuit 704 that provides guidance to the functions of the preparation device may be provided by the electronic device 710.

The interface for the electronic device 710 may include a customized experience based on data about the user 101 that may be available to the electronic device 710. For example, certain recipes or food prepared by the user 101 may be used for providing future recommendations of food and/or recipes. There may be a machine learning component to the guidance circuit 104 and/or the electronic device 710 for learning the habits or interests of the user 101. The learning component can tailor the guidance and recommendations.

There may be an option for saving, sharing, or publishing food preparation. In one embodiment, the sharing may be over a social network website. For example, users may connect with one another to share recipes or tips for food preparation. One user can follow another user to receive those recipes or tips to be used with the food preparation device. Recipes can be accessed online through a database of examples or shared by other users in a social network.

In some embodiments, there may be an application (e.g. app on a mobile device) based on a connection with the device. When the product is connected with the mobile device, the app may allow users to customize a recipe (e.g. substitute ingredients, change serving size, etc.). In other embodiments, the app may allow users to make recipe recommendations based on a user's diet, preference, or food available at home. In other embodiments, the app may allow users to save and retrieve favorite recipes and/or cooking settings. In other embodiments, the app may support (hands-free) voice interaction (recognize voice commands, and provide voice guidance). In other embodiments, the app may allow users to customize output of the device (e.g. sounds such as beeps for on/off, volume, tone, etc.).

The guidance circuit 104 may be used for implementing the processes shown in the embodiments of FIGS. 8-9. The guidance circuit 104 provides recommendations to the user 101 for the proper order of different functions. Further, the guidance circuit 104 can prevent certain combinations of functions (e.g. Defrost after Cooking). The guidance provides instructions for the user.

Staged cooking may refer to different stages of the process. The stages may be functions that are operated in proper order. Upon selection of a first function, then the guidance will display the possible second functions. For example, the Defrost function will not be available after any of the Cooking options. The limited options provided to the user may be part of the guidance. The limiting of the options may be referred to as feedback. In some embodiments, the output or message bar may be utilized for providing instructions and feedback to the user.

FIG. 8 illustrates example inputs and outputs for guidance. The guidance 806 may be performed by the guidance circuit in some embodiments. The guidance 806 may receive an initial user input, which may include an initial instruction 802. The instruction 802 may include a function to be performed by the preparation device. In some embodiments, the initial instruction 802 may be a type food to be prepared. Based on the initial instruction 802, the guidance 806 may be performed.

In some embodiments, there may be sensors 804 that can be used either in addition to the initial instruction 802, or in place of the initial instruction 802. The sensors 804 may measure conditions of the food (e.g. weight, temperature, density, volume, crispiness, burned particles, etc.) or conditions of the environment in the food preparation device (e.g. humidity, temperature, etc.) to determine a function or to determine how to prepare the food for a particular function. In some embodiments, the sensors 804 may identify the food and determine the function. In other embodiments, the data measured by the sensors 804 may be used to improve the guidance 806. The guidance 806 may provide an instruction 808 that is provided to the user. The instruction 808 may be displayed or otherwise communicated to the user and may include a limited set of options for proceeding based on the initial instruction 802 and/or based on data detected by the sensors 804. The guidance 806 can limit the options for the next instruction 808 based on either the initial instruction 802 and/or the sensors 804.

The guidance 806 may also automatically perform the next instruction 810. In this embodiment, the guidance 806 performs the functions without user interaction, which may be referred to as staged cooking. While not providing guidance to the user or requiring subsequent user interaction, staged cooking with the automatic performance of the food preparation device may be considered a type of guided cooking. Alternatively, the user may provide subsequent interaction with the next instructions 808 in some embodiments.

In one embodiment, the instructions may include a recipe for a particular food. The recipe may include the preparation recommendations along with the food. The recipe may be part of the initial instruction 802. In some embodiments, the recipe may be identified by an external computing device (e.g. the electronic device 710) and is used as the input for the guidance 806.

FIG. 9 illustrates a flow process for one example of guidance with a preparation device. In block 902, a first function is received from the user at the food preparation device. The function may include at least one of a cooking, pressure cooking, slow cooking, frying, air frying, baking, roasting, broiling, reheating, steaming, dehydrate, defrosting, microwaving sautéing, searing, grilling, coffee grinding, brewing, dispensing, or blending. Based on the identified first function, there may be analysis in block 904 for providing the user with guidance. If there is additional data in block 906, that data can be provided for the analysis in block 908. The additional data may be an input from the user about the first function or the food preparation or it may be from sensors that provide data about the food and/or the food preparation device. Based on the analysis in block 904 (with or without additional data in block 908), the user is provided with guidance in block 910. In one embodiment, the guidance is a sequence of additional functions to be performed after the first function. The sequence may be limited based on the first function and based on the additional data.

One specific example of guided food preparation may be making yogurt. The food preparation process for yogurt can be difficult, so the guidance provided can help the user. An example of the process for a pot food preparation device is shown in Table 1:

TABLE 1
Guided preparation for yogurt.

| | | Progress |
|---|---|---|
| Steps | Messages/Beeps | Bar |
| Stage 1. Pasteurization | | |
| Cooking 30 min to reach 185 F. | Step 1. Pasteurize | Blinking |
| | | first bar |
| After pasteurization ends | Open lid to cool | Blinking |
| | down | second bar |
| (If sensed) lid is open | Cooling Down | |
| (If sensed) the inner pot is removed | Return Pot | |
| (When sensed) temp is cooled to 106 F. | Add Yogurt Starter | |
| (If sensed) lid is not properly closed | Close Lid or Slide | |
| | to lock lid | |
| Stage 2. Ferment | | |
| Cooking continues for 8 hrs | Step 2. Ferment | Blinking |
| (available range 6-24 hrs) | | third bar |
| After ferment ends | End | |
| Exceptions/Errors | | |
| If the pot is not returned or lid is not | Ready | Cooking is |
| properly closed for over 30 min | | cancelled |

The yogurt example in Table 1 is an example of Staged Cooking that may utilize the interfaces shown above, such as the one shown in FIG. 5. The Steps may include selections that are presented to the user in the message bar. The messages may be displayed from the message bar 302. Above the message bar 302 is a progress bar that displays the progress for each of the stages. As shown in Table 1, the first stage/step includes messages that require user interaction, such as “Open lid to cool down.”

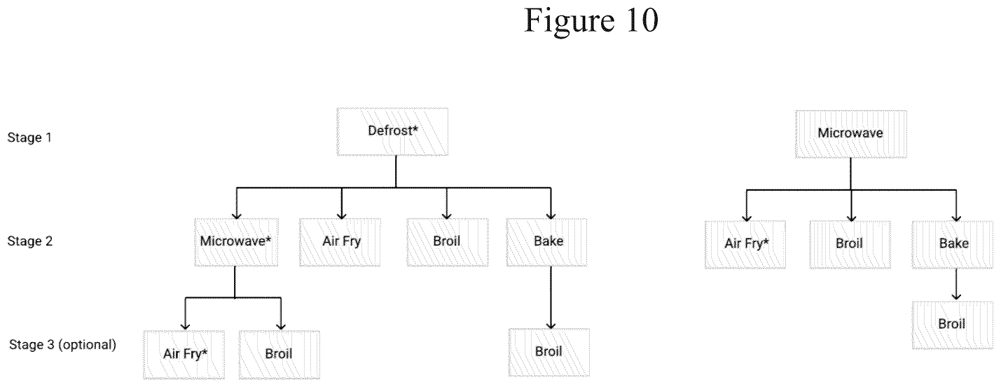

FIG. 10 illustrates a flow process for example functions. The guidance may include a sequence of functions for the user. In particular, the user may be limited in which functions are available based on previous functions or other information about the food preparation (e.g. sensor data, etc.). In FIG. 10, limitations for the sequence of functions are shown. Preventing the user from selecting an improper sequence of functions results in a food preparation device that is more user friendly. The example shown in FIG. 10 is described as stages, but may also be considered to be a sequence of functions as described herein. In this example, Defrost is always first and cannot follow other functions. In another example, when the Microwave function is performed first, the subsequent functions available are Air Fry, Broil, or Bake. After Bake, there can be a Broil function for a third stage. As described, the analysis performed may consider the sequence of functions to provide guidance to the user for efficient food preparation.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kind like a client-server architecture or an Internet/browser network) in which the invention may be implemented. The invention will be described in general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random-access memories (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used. These and other input devices are often connected to the processing unit through a serial port interface coupled to system bus. Other interfaces include a universal serial bus (USB). Moreover, a monitor or another display device is also connected to the computers of the system via an interface, such as video adapter. In addition to the monitor, the computers typically include other peripheral output or input devices (not shown), such as speakers and printers or interfaces for data exchange. Local and remote computer are coupled to each other by logical and physical connections, which may include a server, a router, a network interface, a peer device or other common network nodes. The connections might be local area network connections (LAN) and wide area network connections (WAN) which could be used within intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

We claim:

1. A method for food preparation comprising:
receiving an initial instruction for the food preparation;
analyzing the initial instruction to identify subsequent preparation actions depending on the initial instruction; and
providing guidance based on the analysis, wherein the guidance comprises a limited option subset for a next instruction for the food preparation.

2. The method of claim 1, wherein the analyzing comprises determining a sequence for the food preparation and the subsequent preparation actions are the next instruction in the sequence.

3. The method of claim 1, wherein the initial instruction comprises one or more functions for preparing the food.

4. The method of claim 3, wherein the one or more functions comprise at least one of a cooking, pressure cooking, slow cooking, frying, air frying, baking, roasting, broiling, reheating, steaming, dehydrate, defrosting, or microwaving, sautéing, searing, grilling, coffee grinding, brewing, dispensing, or blending.

5. The method of claim 1, further comprising:
measuring, with one or more sensors, one or more conditions of the food; and
modifying the guidance based on the measured one or more conditions.

6. The method of claim 5, wherein the measured condition comprises a weight, temperature, humidity, density, volume, crispiness, or burned particle.

7. A food preparation device comprising:
one or more food preparation functions selectable by a user;
a guidance circuit configured to:
receive an initial instruction for the selected function;
analyze the initial instruction to identify subsequent functions depending on the initial instruction; and
providing guidance based on the analysis, wherein the guidance comprises a limited subset of the functions for a next instruction.

8. The food preparation device of claim 7, wherein the analysis comprises determining a sequence for the functions and the next instruction in the sequence is a next function in the sequence.

9. The food preparation device of claim 7, wherein the initial instruction comprises one or more of the functions for preparing the food.

10. The food preparation device of claim 7, wherein the one or more functions comprise at least one of a cooking, pressure cooking, slow cooking, frying, air frying, baking, roasting, broiling, reheating, steaming, dehydrate, defrosting, or microwaving, sautéing, searing, grilling, coffee grinding, brewing, dispensing, or blending.

11. The food preparation device of claim 7, wherein the guidance circuit is further configured to:
measure, with one or more sensors, one or more conditions of the food; and
modify the guidance based on the measured one or more conditions.

12. The food preparation device of claim 11, wherein the measured conditions comprise a weight, temperature, humidity, density, volume, crispiness, or burned particle.

13. A food preparation system comprising:
the food preparation device from claim 7;
an electronic device communicating with the food preparation device.

14. The food preparation system of claim 13, wherein the electronic device comprises a mobile device with an application for interacting with the food preparation device.

15. The food preparation system of claim 13, wherein the one or more food preparation functions comprise preset functions.

16. The food preparation system of claim 15, wherein the user selects one of the preset functions and the guidance is based on the selected preset function.

17. A method for food preparation comprising:
providing preset options for the food preparation;
receiving a selection for one of the present options; and
providing guidance based on the received selection, wherein the guidance comprises a limited option subset for a next instruction for the food preparation.

18. The method of claim 17, wherein the receiving a selection comprises a user cycling through the preset options and identifying one of the preset options.

19. The method of claim 17, further comprising:
displaying multiple preset buttons corresponding with the preset options, wherein the preset buttons are configured to be set by a user.

20. The method of claim 19, wherein the receiving the selection comprises the user selecting one of the displayed preset buttons.
